(19) United States
(12) Patent Application Publication
(10) Pub. No.: US 2008/0089484 A1
(43) Pub. Date: Apr. 17, 2008

(54) Nanofocus x-ray tube

(76) Inventor: Alfred Reinhold, Wunstorf (DE)

Correspondence Address: SHLESINGER, ARKWRIGHT & GARVEY LLP, 1420 KING STREET, SUITE 600, ALEXANDRIA, VA, 22314, US

(21) Appl. No.: 11/593,636

(22) Filed: Nov. 7, 2006

(30) Foreign Application Priority Data
Nov. 7, 2005 (DE) 10 2005 053 386.8

(51) Int. Cl. H01J 35/14

(52) U.S. Cl. 378/138

(57) ABSTRACT

Nanofocus x-ray tube, includes a target, and a device for directing an electron beam onto the target. The target includes at least one target element made of a target material for generating x-rays, the at least one target element including a nanostructure having a diameter ≦about 1000 nm. The nanostructure is formed by a microstructuring procedure on a substrate element made of a substrate material, and the target element only partly covers the substrate element. The electron beam cross-section of the x-ray tube, in use, is selected to be sufficiently larger than the cross-section of the target element, such that the electron beam always irradiates the entire surface of the target element. Still further, the substrate material may be diamond, or the substrate material may include diamond, and being doped to raise the electrical conductivity.

### CROSS-REFERENCE TO RELATED APPLICATIONS

This application claims priority of German application no. 10 2005 053 386.8, filed Nov. 7, 2005, and which is incorporated herein by reference.

### FIELD OF THE INVENTION

The present invention relates to a nanofocus x-ray tube as defined in the preamble of claim 1.

### BACKGROUND OF THE INVENTION

Nanofocus x-ray tubes of this kind are generally known. They include a target and means to direct an electron beam onto the target. For example, as regards imaging, they are used in high-resolution inspection of components such as printed circuit boards used in electronics. In order to achieve high spatial resolution in such imaging procedures, the electron beam of known nanofocus x-ray tubes is shaped in a manner that at incidence on the target, a focal point having a diameter ≦1,000 nm is formed.

Nanofocus x-ray tubes generating such small electron beam diameters are known which operate on the principle of x-ray diffraction and in which Fresnel lenses are provided. Such nanofocus x-ray tubes allow for generation of focal point diameters as small as about 40-30 nm, and wherein the electrons are accelerated toward the target at a relatively low energy of about 20 KeV limited by the operating conditions.

Moreover nanofocus x-ray tubes are known using refracting lenses. Such nanofocus x-ray tubes allow for generation of focal point diameters as small as about 1,000 nm, wherein only relatively low electron-accelerating energies of about 20-30 KeV being appropriate.

Moreover nanofocus x-ray tubes are known in which the desired small diameter and hence the cross-section of the electron beam are achieved, and which use the beam path crossing a plurality of sequentially arrayed electromagnetic lenses. Such nanofocus x-ray tubes allow the generation of focal point diameters as small as about 100-200 nm, wherein, for example, the electrons may be accelerated using an energy of 100 KeV to generate a focal point diameter of 1,000 nm.

A disadvantage of the known nanofocus x-ray tubes is that, in order to achieve a desired small cross-section of the electron beam, they entail considerable equipment, for instance a plurality of electromagnetic lenses, at the site of beam incidence on the target. Accordingly such nanofocus x-ray tubes are complex and expensive to manufacture.

### OBJECTS AND SUMMARY OF THE INVENTION

The object of the invention is to create a nanofocus x-ray tube of the kind set forth in the preamble of claim 1 that achieves the generation of the small focal point diameter ≦1,000 nm required for high-resolution inspection of components by providing a simplified construction and hence more economical manufacture.

This object is achieved by the teachings set forth in claim 1.

In the first place, the present invention abandons the concept of achieving the desired small focal point diameter by appropriately shaping the target impacting electron beam. Instead the present invention is based on the idea to construct the nanofocus x-ray tube in a manner so that the focal point diameter is not dependent on the electron beam cross-section, rather dependent solely on the cross-section of a target element. For that purpose the teaching according to the present invention provides that the target includes a target element made of a target material and suitable for x-ray emission, the target element being constituted by a nanostructure ≦1,000 nm formed on a substrate element made of a substrate material, the target element only partially covering the substrate element. In accordance with the invention, when operating the x-ray tube, the electron beam cross-section at the target element impact site is selected larger than the target element cross-section in a manner that the electron beam always irradiates the entire surface of the target element. As a result, even in the event of cross-sectional changes of the electron beam incident on the target element, illustratively due to an increase or decrease in cross-section, a lateral shift from the electron beam direction, or distortion of this electron beam, the target element, which defines the shape and size of the focal point, always is irradiated by the electron beam.

In the present invention, the substrate material and the target material are different. The target element materials are selected in relation to x-ray emissions of a desired wavelength or within a given range of wavelengths, whereas the substrate material, namely diamond, is primarily selected based on its heat conductivity coefficient. To this extent the present invention is based on the insight that, for instance, when using a diamond substrate material, the generated heat is adequately dissipated whereas at the same time, due to the electrical insulator features of diamond, the target is electrically charged. In this respect the present invention also is based on the insight that the electrical target charge degrades the image quality of the imaging procedure, as regards for instance uncontrolled freeing/separation of charges, and re-impacting the target element may entail uncontrolled, additional x-ray emission. The present invention makes used of a diamond substrate material which is electrically insulating but is made electrically conductive by being doped with an appropriate doping material, for instance a metal. As a result electrical charges, for instance electrons, may be drained off the target and thereby electrical target charging, which degrades image quality, is reliably precluded. Surprisingly it was determined that in this manner the imaging quality was significantly improved in a nanofocus x-ray tube of the present invention.

The electrical conductivity achieved by doping the substrate material may vary within wide limits to meet particular requirements. The doping material also may be selected within wide limits.

In the present invention, the substrate element's cross-section defined perpendicular to the beam direction is larger than the target element's cross-section in the same direction, wherein the target element only partially covers the surface of the substrate element. Moreover the substrate material exhibits a lower density, high heat conductivity and, due to the doping of the present invention, also the ability to drain away electrical charges, whereas the target element material is of high density, for instance tungsten. Incident electrons are decelerated over a very short path, wherein preferably short x-ray wavelengths being generated thereby. On the other hand electrons penetrating low-density substrate material are decelerated over very long paths, resulting in radiation of longer wavelength, which, for example, may be filtered out using an appropriate filter. In this manner the present invention achieves the determination of the shape, size and site of the focal point by means of the shape, size and site of the target element.

Because the present invention generates the x-ray radiation of desired wavelength or within a desired range of wavelengths exclusively, and the target element thereby defines the x-ray tube's focal point, the shape and size of this focal point are no longer dependent on the electron beam cross-section but solely on the cross-section of the target element, provided that in x-ray tube operation, the electron beam shall always irradiate the full target element area. It is also true that x-rays are generated in the substrate material. However those x-rays have other wavelengths, or fall within another range of wavelengths, than the desired x-ray radiation from the target element, and can be easily filtered out. As a result the present invention provides for making the focal point of a nanofocus x-ray tube target almost arbitrarily small, the limits being determined merely by the available microstructuring methods to form nanostructures.

Given that the focal point's shape, size and site being exclusively determined by the shape, size and site of the target element, the nanofocus x-ray tube of the present invention is free of the conventional complex manufacturing steps required to stabilize the shape, size and site of the electron beam. In this manner the target of the present invention allows a most economical construction of a nanofocus x-ray tube of exceedingly stable focal point shape, size and site and allowing especially high quality when used in imaging.

Depending on the particular requirements, the target element material may be one emitting x-rays of a desired wavelength or one within a desired range of wavelengths when bombarded by electrons.

A nanofocus x-ray tube of the present invention may be construed as one of which the focal point ≦1,000 nm.

In the present invention, a non-circular focal point's diameter may be understood as being its longest size in the focal plane.

The numerical values of the thermal conductivity coefficient relate to room temperature.

Because in the present invention the shape, size and hence the cross-section of the nanofocus x-ray tube's focal point depend solely on the shape, size and cross-section of the target element, the implementation of the present invention no longer requires highly accurately shaping the electron beam at the impact site of the target. Consequently the present invention no longer requires means implementing highly accurate shapes, as required in prior art nanofocus x-ray tubes, of the electron beam cross-section. Basically the present invention requires only a single focusing device, for instance in the form of an electromagnetic lens. Accordingly the equipment cost of the nanofocus x-ray tube of the present invention is substantially lower, making it substantially simpler and hence more economical to manufacture.

The nanofocus x-ray tube of the present invention offers the particular advantage of being much less susceptible to interferences affecting electron beam shapes than conventional tubes.

As the shape and the size of the focal point of the present invention exclusively depend on the shape and size of the target element, the focal point size of a nanofocus x-ray tube of the present invention depends exclusively on the attainable spatial resolution of the particular microstructuring method used. Applicable microstructuring procedures may include deposition procedures such as three-dimensional additive nanolithography or ion beam sputtering, as well as abrasive procedures such as electron lithography or etching. Nanostructures having diameters or 2 nm or even less may be achieved in particular with deposition procedures. Accordingly the disclosure of the present invention offers nanofocus x-ray tubes of which the spatial imaging resolution is substantially higher than found in conventional nanofocus x-ray tubes.

An extraordinarily advantageous further development of the present invention provides that the substrate element be made at least partially of a substrate material of which the heat conductivity ≧10 W/(cm×° K), preferably ≧20 W/(cm×° K). The heat conductivity of the substrate material is especially high and thereby the heat generated by electrons bombarding the target element is dissipated especially well. This feature extends the life of the target of the present invention.

In accordance with the present invention it is sufficient if only one target element is mounted on the substrate element. It is also possible in accordance with the invention to also mount several mutually spaced target elements on the substrate element. In the case of such an embodiment, should one target element become worn out, the electron beam thereupon can be deflected onto another target element, thus providing continued x-ray tube use without need for an exchange.

In principle the target element geometry may have any desired configuration. In order to achieve high image quality in an imaging procedure, an advantageous further embodiment of the present invention provides that at least one target element of the nanofocus x-ray tube includes a circular boundary.

Another advantageous further embodiment of the disclosure of the present invention provides that the target element be provided with a filter transparent to the x-rays generated in the target element while being opaque to the x-rays generated in the substrate element. In this manner it is ensured that a nanofocus x-ray tube of the present invention will reliably always radiate x-rays of a desired wavelength or be within a desired range of wavelengths.

Basically the nanofocus x-ray tube's target may be a solid target (direct beam target) including a thermally highly conductive metal block, for instance of copper or aluminum, onto which the inventive substrate element is mounted in the form of a substrate layer, and which in turn supports the target element. In another advantageous development of the present invention, however, the target is configured as a transmitting target.

The present invention is elucidated below in relation to the substantially schematic appended drawing showing illustrative embodiments of a target according to the invention. Per se or taken in any combination with one another, all features that are claimed, discussed or shown in the drawing do constitute the object of the present invention, regardless of being summarized in the claims or of being dependent on some previous claim and regardless of their formulation or representation in the description or in the drawing.

### BRIEF DESCRIPTION OF THE DRAWINGS

FIG. 1 is a sectional elevation of an embodiment of a target of the invention illustrating the basic principle of the invention;

FIG. 2 is an elevation similar to that of FIG. 1;

FIG. 3 is a top view of the target of FIG. 1;

FIG. 4 is a sectional view of a second target of the invention;

FIG. 5 is a top view of the target of FIG. 4;

FIG. 6 is a top view similar to that of FIG. 5;

FIG. 7 is another top view similar to that of FIG. 5; and

FIG. 8 is a schematic view illustrating the principle of an illustrative embodiment of a nanofocus x-ray tube of the invention.

### DETAILED DESCRIPTION OF THE INVENTION

The same or corresponding components shown in the Figures of the drawing are referenced by the same reference numerals.

The Figures of the drawing are purely schematic sketches depicting principles, and are not to scale.

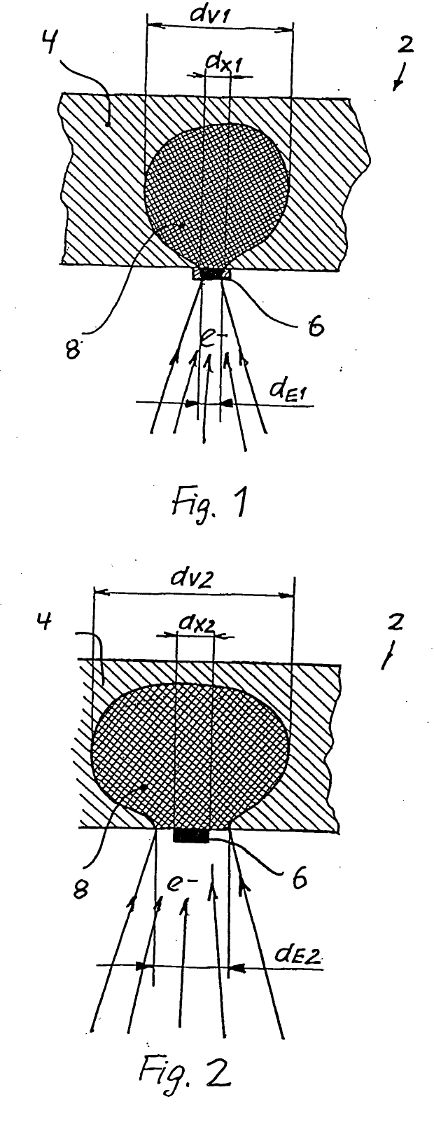

FIG. 1 shows a first embodiment of a nanofocus x-ray tube's target 2 including a substrate element 4, and which in this embodiment, includes an x-ray emitting target element 6 mounted to the substrate element 4 and made of a target material. The substrate element 4 is principally made of a substrate material of low density and high heat conductivity, namely diamond, of which the heat conductivity is ≧20 W/(cm×° K).

In accordance with the invention, the diamond used as substrate material is doped, in the present embodiment with metal ions, to increase its electrical conductivity. Because doping renders the substrate material electrically conductive, electric charges are able to drain off the substrate element 4, so that electric charging of the substrate element 4 and hence of the target 2 is avoided.

The target element 6 consists of a material of high density, in the present embodiment tungsten, which emits x-rays when being bombarded with electrically charged particles, in particular electrons.

In FIG. 1 it is not visible that the target element 6 when seen in top view is substantially peripherally circular and in this embodiment includes a diameter approximately ≦1,000 nm.

In this embodiment the target element 6 is a nanostructure made by means of a microstructuring procedure on the substrate element 4.

When the target 2 is bombarded with electrons, these electrons are decelerated over a very short path inside the target element 6, wherein short-wave x-ray radiation is then produced. Electrons penetrating the low density substrate material of the substrate element 4 on the other hand are decelerated over very long paths, wherein long-wave radiation is produced. FIG. 1 shows a case wherein an electron beam of diameter d_{E1} impacts the target element 6, the diameter d_{E1} in this instance being smaller than the diameter of the target element 6. The electron deceleration in the target element 6 entails a short-wave x-ray radiation of a source diameter d_{X1} which is smaller than or equal to the diameter of the target element 6. The electrons passing through the target element 6 into the lower density substrate material of the substrate element 4 are decelerated over a very long path within the deceleration volume of the substrate element 4 and generate a predominantly long-wave radiation that can be blocked using appropriate filters, wherein only the short-wave radiation portion produced by the target element 6 is operative, this target element 6 according to the invention only covering a portion of the substrate element 4.

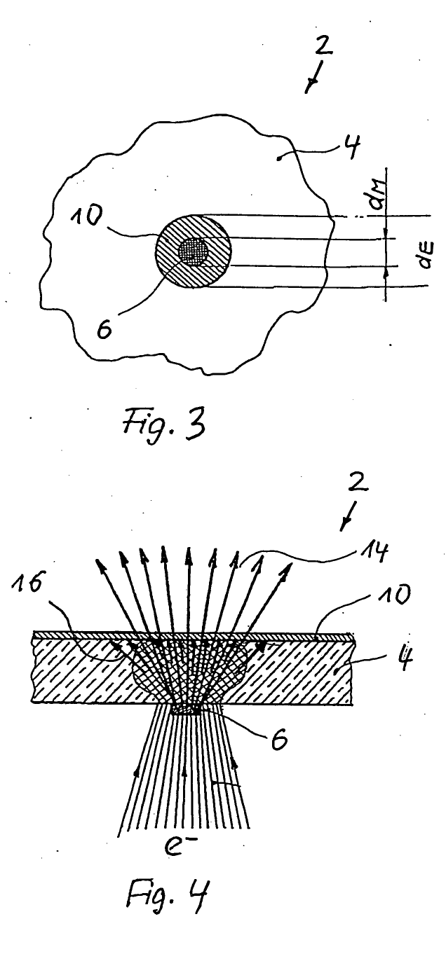

FIG. 2 shows a case wherein the cross-sectional diameter d_{E2} of the electron beam is substantially larger than the diameter of the target element 6. In this case too the predominantly shortwave radiation produced in the well defined target element 6 having a diameter d_{X2} whereas the electrons penetrating the lower density material of the substrate element 4 result in radiation of longer wavelength within the deceleration volume 8, the long-wave radiation being separable by filtering so that only the short-wave radiation from the target element 6 exhibiting a defined wavelength or a defined range of wavelengths shall become operative.

A comparison of FIGS. 1 and 2 shows that the shape, size and site of the focal point of the x-ray tube are solely dependent on the shape, size and site of the target element 6, not on the shape, size and site of the electron beam's cross-section.

FIG. 3 is top view of the target of FIG. 2, showing that the diameter d_{E} and hence the electron beam cross-section 10 is larger than the diameter d_{M} and hence the cross-section of the target element 6. As elucidated with respect to FIGS. 1 and 2, the cross-section of the substrate element 6 solely determines the x-ray tube's focal point cross-section.

FIG. 4 shows a second embodiment of a target 2 of the invention configured as a transmission target which differs from the embodiment of FIG. 1 in that the substrate element 4 is provided on its side facing away from the target element 6 with a beam filter 12 which is substantially transparent to the x-ray radiation 14 generated in the target element 6 but substantially opaque/absorbing with respect to the x-ray radiation 16 generated in the substrate element 4. Illustratively the filter 12 may be an aluminum sheet.

In FIG. 5, a preset electron beam cross-section is denoted by 10 whereas the reference numeral 18a therein denotes an electron beam cross-section that was reduced on account of interference and 18b denotes an electron beam cross-section that was enlarged on account of interference. The x-ray tube's focal point cross-section depending only on the cross-section of the target element 6, and latter being constant, fluctuations in electron beam cross-section do not affect focal point cross-section as long as the target element 6 is irradiated over its entire surface by the electron beam.

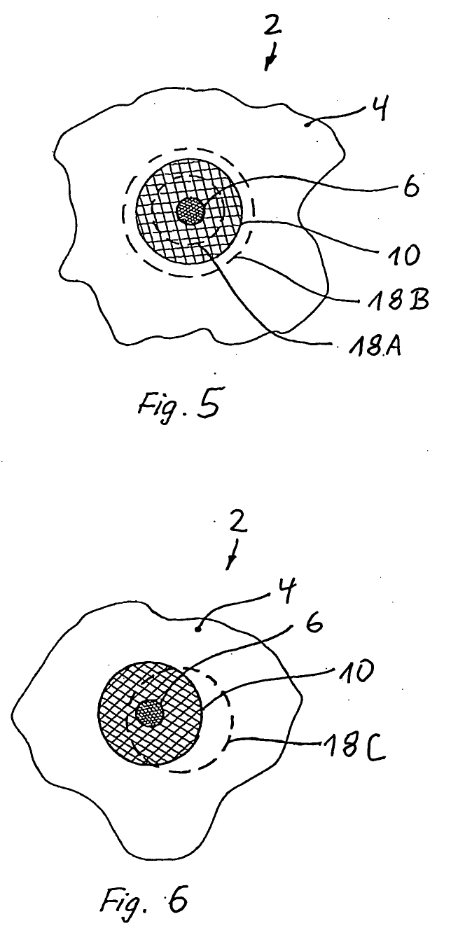

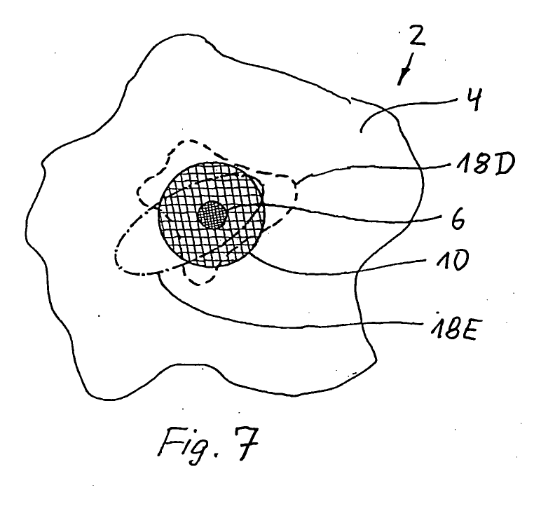

As shown by FIG. 6, the same considerations also apply to a lateral shift of the electron beam into a position 18C because the target element 6 is irradiated by the electron beam over its entire surface also in this position.

As shown by FIG. 7 even changes in electron beam cross-section do not affect the focal point cross-section as long as the target element 6 remains irradiated over its full surface. FIG. 7 shows merely by way of example two distorted electron beam cross-sections 18D and 18E. As the focal point cross-section depends solely on the cross-section of the target element 6, which is constant and fixed in place, cross-sectional changes of the electron beam do not degrade x-ray image quality when using a target 2 of the invention in an imaging x-ray tube.

As can be seen by comparing FIGS. 5 through 7, cross-sectional changes and shifting of the electron beam do not affect the focal point's cross-section and site. Accordingly the x-ray tube of the invention does not require complex construction features to achieve adequate imaging quality that are essential in conventional x-ray tubes to stabilize their electron beams' shapes, sizes and impact sites on the target 2. Hence an x-ray tube of the invention is much simpler and economical to manufacture.

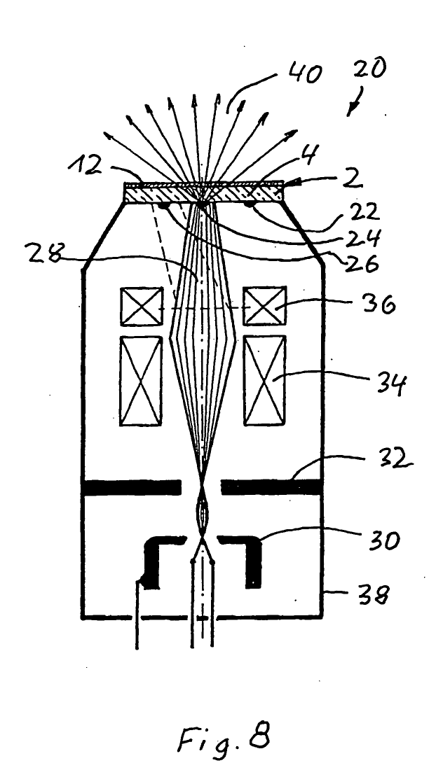

FIG. 8 shows an operational sketch of an illustrative embodiment of the nanofocus x-ray tube 20 of the invention, hereafter termed merely “x-ray tube” for the sake of brevity. The x-ray tube 20 includes a target 2 of the invention which in this particular embodiment is provided with three mutually spaced target elements 22, 24, 26 along the target surface.

The x-ray tube 20 of the invention also is provided with means that direct an electron beam 28 onto the target 2. The means in this embodiment includes a cathode 30 and a hole anode 32 by means of which for example electrons emitted from a filament accelerated at high energies are directed onto the target 2.

The x-ray tube 20 moreover includes a focusing device 34 provided behind the hole anode 12 as seen in the beam direction to focus the electron beam 28 onto the target 2. The focusing device 34 may be, in a generally known manner, in the form of a conventional coil system.

In this embodiment the x-ray tube 20 also is provided with deflecting elements 36 to deflect the electron beam in a manner that it shall impact selectively one of the target elements 22, 24 or 26. By means of the deflecting elements 36, the electron beam 28 illustratively may be deflected onto another target element when a previously operating target element becomes worn. In the invention, the purpose of the deflecting elements 36 is to deflect the electron beam 28, not the shaping or focusing of it. As regards embodiments wherein the target 2 merely bears a single target element, the deflecting elements 36 are not needed.

To filter out the x-ray radiation generated in the substrate element 4 of the target 2 of the invention, the target is provided at its side facing away from the target elements 22, 24, 26 with a filter 12 which was discussed more particularly above in relation to FIG. 4.

The components of the x-ray tube 20 of the invention are conventionally received in a housing 38 of this tube that can be evacuated during operation.

A control system, unillustrated in the Figure, drives the control elements 36 deflecting the electron beam 28 onto one of the target elements 22, 24, 26. The configuration of the electric power supply and the operation of the x-ray tube 20 are generally known and therefore are not discussed in detail herein.

When the x-ray tube 20 of the invention is operated, the electron beam 28 is accelerated by the hole anode 32 toward the target 2, focused by the focusing device 34, and deflected by the deflecting element 36 onto one of the target elements 22, 24, 26. Upon impact, and ensuing deceleration, of the electrons on, or respectively in, one of the target elements 22, 24, 26, x-ray radiation of a desired wavelength, or within a desired range of wavelengths, is created. The x-ray radiation generated by electron deceleration in the substrate element 4 is separated by the filter 12, as a result of which the x-ray tube 20 emits an x-ray radiation 40 exclusively of the desired wavelength, or within the desired range of wavelengths.

As the shape, size and site of the focal point of the x-ray tube 20 are defined exclusively by the particular target element 22, 24, 26, interferences affecting the shape, size and impact site of the electron beam 28 on the target 2 do not affect the shape, size and site of the focal point of the x-ray tube 20, as already discussed above in relation to FIGS. 5 through 7.

Accordingly, the inventive x-ray tube 20 having a simple construction, and basically employing only one focusing device 34, makes possible high spatial and dimensional stability of the focal point and hence, as regards imaging, especially high resolution and image quality.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. A nanofocus x-ray tube, comprising:
a) a target;
b) a device for directing an electron beam onto the target;
c) the target including at least one target element made of a target material for generating x-rays, the at least one target element including a nanostructure having a diameter ≦about 1000 nm, the nanostructure being formed by a microstructuring procedure on a substrate element made of a substrate material, and the target element only partly covering the substrate element;
d) the electron beam cross-section of the x-ray tube, in use, being selected to be sufficiently larger than the cross-section of the target element, such that the electron beam always irradiates the entire surface of the target element; and
e) the substrate material being one of diamond and including diamond, and being doped to raise the electrical conductivity.

2. Nanofocus x-ray tube as claimed in claim 1, wherein:
a) the substrate element at least in part includes a substrate material of which the thermal heat coefficient ≧10 watt/(cm×K).

3. Nanofocus x-ray tube as claimed in claim 2, wherein:
a) the substrate element supports a plurality of mutually spaced target elements.

4. Nanofocus x-ray-tube as claimed in claim 1, wherein:
a) the at least one target element is bounded in a substantially circular manner.

5. Nanofocus x-ray tube as claimed in claim 1, wherein:
a) the target is a transmission target.

6. Nanofocus x-ray tube as claimed in claim 1, wherein:
a) the substrate element supports a plurality of mutually spaced target elements.

7. Nanofocus x-ray tube as claimed in claim 1, wherein:
a) the target includes a filter transparent to the x-rays generated in the at least one target element and opaque to the x-rays generated in the substrate element.

8. Nanofocus x-ray tube as claimed in claim 2, wherein:
a) the substrate element at least in part includes a substrate material of which the thermal heat coefficient ≧20 watt/(cm×K).

9. Target as claimed in claim 1, wherein:
a) the target includes a filter transparent to the x-rays generated in the at least one target element and opaque to the x-rays generated in the substrate element.
